(19) United States
(12) Patent Application Publication
(10) Pub. No.: US 2014/0356763 A1
(43) Pub. Date: Dec. 4, 2014

(54) REPEATING UNIT FOR A FUEL CELL STACK

(71) Applicant: Staxera GmbH, Dresden (DE)

(72) Inventor: Andreas Reinert, Dresden (DE)

(21) Appl. No.: 14/462,355

(22) Filed: Aug. 18, 2014

Related U.S. Application Data
(63) Continuation of application No. 13/130,170, filed on May 19, 2011, now abandoned.

(30) Foreign Application Priority Data
Jan. 26, 2009 (DE) 10 2009 006 157.6
Feb. 16, 2009 (DE) 10 2009 009 177.7

(51) Int. Cl. H01M 8/04

(52) U.S. Cl. CPC H01M 8/04201; H01M 2250/20
USPC 429/513

(57) ABSTRACT

A repeating unit (10) for a fuel cell stack comprises a gas conducting region (8) for conducting a first gas (12) to and along an active surface (14). A barrier (16) is located in the gas conducting region. The gas conducting region comprises, at least over the active surface, a plurality of channels (20, 22, 24, 26, 28, 30, 32, 34) for conducting the first gas along the active surface. At least a first channel (26) among the plurality of channels defines a first flow direction at a first point (46) located closest to the barrier and a second flow direction at a second point (48), wherein a first straight line (50) which extends through the first point (46) and is parallel to the first flow direction misses the barrier (16) while a second straight line (52) which extends through the second point (48) and is parallel to the second flow direction intersects the barrier. The barrier (16) can he located upstream or downstream of the active surface (14).

The invention relates to a repeating unit for a fuel cell stack comprising a gas conducting region for conducting a first gas to and along an active surface, wherein a barrier is located in the gas conducting region, and the gas conducting region comprises, at least across the active surface, a plurality of channels for conducting the first gas along the active surface.

The invention further relates to a fuel cell stack comprising a repeating unit according to the invention.

The invention further relates to a vehicle comprising a fuel cell stack, as well as combined heat and power generation equipment comprising a fuel cell stack.

Similar to batteries, fuel cells serve to convert chemical energy into electric power. The essential components of a fuel cell are a cathode, an anode, as well as a membrane which separates the cathode from the anode. Cathode, anode and membrane form what is commonly known as the membrane electrode assembly or MEA. During operation of the fuel cell, the cathode is supplied with an oxidation gas (typically air), and the anode is supplied with a combustion gas (typically a hydrogen-rich reformate). The combustion and oxidation gases react with each other, and in doing so, an electric voltage is generated between the anode and the cathode. Since this voltage is usually low (typically less than 1 volt), it is common practice to electrically connect a plurality of fuel cells in series. Such a series connection is realised by what is commonly known as a fuel cell stack. A fuel cell stack may theoretically be disassembled into a plurality of identical repeating units periodically stacked on top of each other in the stacking direction.

The stacking direction will hereinafter also be referred to as the vertical direction or z-direction. In this regard, it is to be understood that the stacking direction may have any orientation relative to the earth's surface.

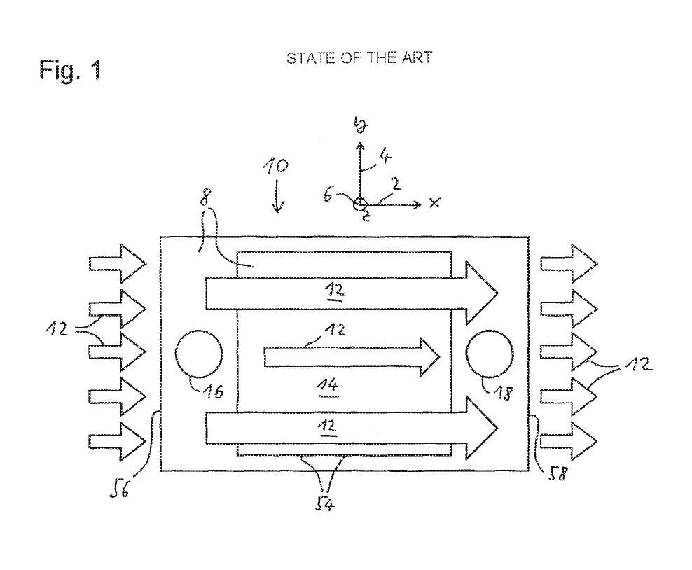

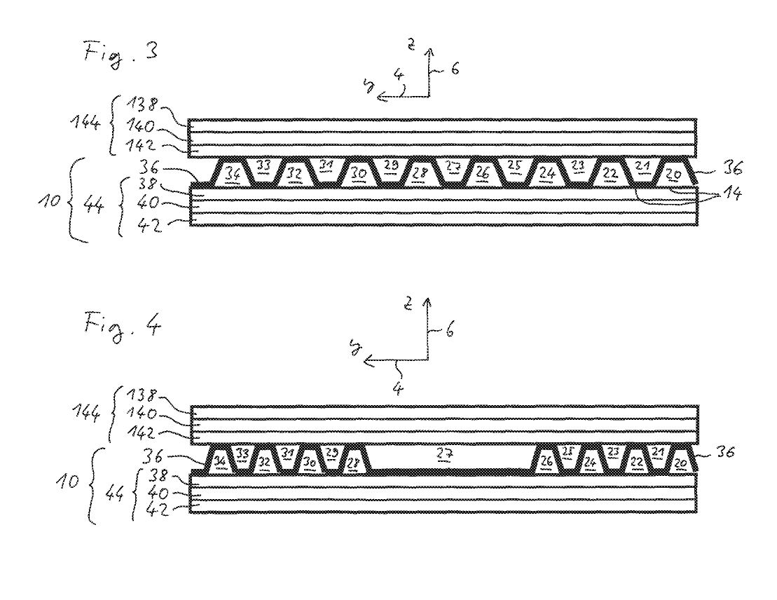

FIG. 1 shows a schematic top view of a repeating unit 10 according to an exemplary embodiment of the state of the art. The repeating unit 10 comprises a gas conducting region 8 for conducting a first gas 12 to and along an active surface 14. In the embodiment shown, the first gas 12 is air, and the active surface 14 is the surface of a cathode layer. In an alternative embodiment (not shown), the active surface 14 is the surface of an anode layer, and the first gas 12 is a combustion gas. The air 12 flows into the gas conducting region 8 through a transverse surface 56 of the gas conducting region 8 in a uniform, laminar flow. The air 12 continues to flow across the active surface 14, and in the process, part of the air 12 reacts with the combustion gas supplied to an anode layer (not shown) of the repeating unit 10. The remaining air 12 flows out of the gas conducting region 8 through a second transverse surface 58 of the gas conducting region 8. The gas conducting region 8 may, particularly in the area of the active surface 14, comprise a plurality of parallel channels extending in the x-direction 2, and also in an area upstream of the active surface 14 and/or downstream of the active surface 14. Parallel linear channels in the gas conducting region 8 will, due to the design, emerge if, for example, the gas conducting region 8 is defined by a corrugated sheet-like bipolar plate towards the “top” (here in the z-direction 6), said bipolar plate separating the illustrated gas conducting region 8 from a region for conducting combustion gas to the anode. Upstream of the active surface 14, the gas conducting region 8 exhibits a barrier 16. The barrier 16 may, for example, be formed by a channel (manifold) extending in the z-direction 6 for conducting combustion gas. In particular, the manifold may be a collection or distribution channel clamped by bipolar plates and seals. The barrier 16 exhibits a dead zone extending from it in the x-direction 2. That means that in case of a uniform flow of air 12 to the gas conducting region 8 on the transverse surface 56, the flow field is no longer uniform in the region behind the barrier 16, particularly on the active surface 14. In the dead zone behind the barrier 16, the flow density of the air 12 is lower. This is schematically indicated in the drawing by the smaller one of the three flow arrows 12 in the gas conducting region 8. Downstream of the active surface 14, a second barrier 18 in front of which the inflowing air 12 accumulates is located in the gas conducting region 8. Thus, the gas barrier 18 generates an accumulation zone in which the flow density of the air 12 is lower than it would be if the barrier 18 were not present. On principle, however, a uniform as possible flow distribution is desirable on the active surface 14. On the one hand, it is to be expected that the effectivity of a fuel cell can be optimised by a flow distribution which is as uniform as possible on the active surface, and on the other hand, a uniform flow on the different regions of the active surface 14 will result in a more homogenous temperature distribution on the active surface and possibly in the entire fuel cell stack. Thermal strain in the fuel cell stack may thus be avoided or at least reduced. Since the introduced air 12 cools in particular the active surface 14 as well as an adjoining or adjacent bipolar plate (see FIGS. 3 and 4), the flow density of the air 12 should not be significantly lower than in the outer regions of the active surface 14, at least in a central region of the active surface 14.

It is the object of the invention to further develop a generic repeating unit so that insufficient flow to a central region of the active surface is avoided. Said object is solved by the characteristic features of claim 1. Further developments and advantageous embodiments of the invention will become apparent from the dependent claims.

The repeating unit according to the invention is based on the generic state of the art in that at least a first channel among the plurality of channels defines a first flow direction at a first point located closest to the barrier and a second flow direction at a second point, wherein a first straight line which extends through the first point and parallel to the first flow direction misses the barrier, while a second straight line which extends through the second point and parallel to the second flow direction intersects the barrier. The first channel thus extends at least in sections within a dead zone or an accumulation zone of the barrier. Since the first channel is not directed towards the barrier at a point located closest to the barrier (i.e. the first point), the channel is adapted to “branch off” flowing gas from a region in which the flow density is relatively high. It may be contemplated that the first point and the second point are located inside or outside of a dead zone of the barrier. Alternatively, it may be contemplated that the first and the second point are located inside or outside of an accumulation zone of the barrier.

The barrier may be located upstream or/and downstream of the active surface. If it is located upstream, it may be particularly advantageous that the first point is located upstream of the second point. If, on the other hand, the barrier is located downstream of the active surface, it may be particularly advantageous that the first point is located downstream of the second point.

It may be contemplated that a cross sectional area of the first channel fully projects on the barrier in a direction perpendicular to the cross-sectional area. In this way, it may be achieved that the first channel is located fully in the dead zone or in an accumulation zone of the barrier, at least in the region of the mentioned cross sectional area.

It is possible that at least the first channel extends beyond the active surface. In this way, enhanced gas distribution can also be achieved in the area of the active surface.

It is even possible that at least the first channel extends beyond the entire fuel cell associated with the first channel.

The active surface may be a partial surface of a membrane electrode assembly; in this case, it may be contemplated that at least the first channel extends beyond the membrane electrode assembly. In a membrane electrode assembly (MEA), the active surface is distinguished from the total surface of the MEA. The active surface is the surface of the electrolytes covered by both electrodes. The total surface is the electrolyte surface in an electrolyte supported fuel cell (ESC) and the anode surface in an anode supported fuel cell (ASC). The first channel may, in particular, extend beyond the total surface of the MEA.

The channels may, in particular, extend in a streamlined fashion. This means that none of the channels has edges or “bends”. In other words, the direction of each channel changes continuously along the channel in question. Turbulences and the resulting friction losses in the channels can be reduced in this way.

The barrier may comprise at least one section of a duct for conducting a second gas. In particular, the duct may be provided for conducting combustion gas to or from an anode of the fuel cell stack. The duct may, for example, be formed as a manifold extending perpendicular to the plane of the active surface.

The active surface may be the active surface of a cathode. In this case, the first gas may, for example, be air or another gas containing oxygen.

The repeating unit may be designed for a uniform laminar flow a the first gas to the gas conducting region.

The channels may be gas-tight with respect to each other. Alternatively, however, the channels may also be formed as open grooves, trenches, or chutes.

It may be contemplated that the plurality of channels includes a second channel and a third channel and that a first edge of the active surface constitutes a closest edge of the active surface for the second channel as well as for the third channel, wherein the third channel extends closer to the first edge and has a smaller cross sectional area than the second channel. Therefore, the third channel located closer to the edge has a smaller cross sectional area than the second channel. This results in a reduced gas flow rate and, thus, to reduced cooling of an edge region of the active surface. Therefore, a uniform temperature distribution on the active surface can be promoted.

The channels may, however, also be formed so that in the case of a uniform flow of the first gas to the gas conducting region, the same amount of the first gas flows through each of the channels. In this way, a particularly uniform use of different regions of the active surface can be achieved.

According to a preferred embodiment, the channels are at least partly defined by a bipolar plate. Therefore, the bipolar plate is not only used to establish an electric contact between two adjacent fuel cells of the fuel cell stack but also to provide the channels.

The fuel cell stack according to the invention is characterised in that it comprises at least one repeating unit according to the invention.

The vehicle according to the invention is provided with a fuel cell stack according to the invention. The vehicle may, n particular, be a motor vehicle, for example, a passenger car or a truck.

The combined heat and power generation equipment according to the invention also comprises a fuel cell stack according to the invention.

The invention will now be described by way of example with reference to the accompanying drawings. Identical or similar numerals designate the same or similar components. Such components are, at least partly, only explained once to avoid repetitions.

FIG. 1 shows a schematic plan view of a first repeating unit;

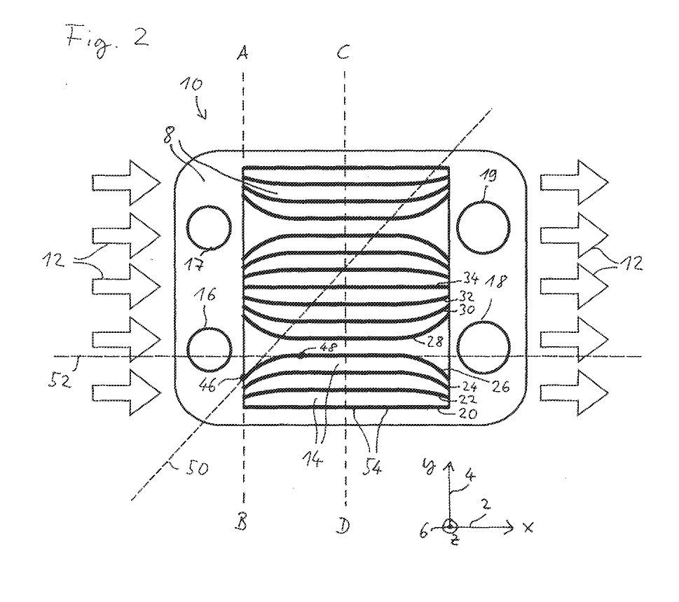

FIG. 2 shows a schematic plan view of a second repeating unit;

FIG. 3 shows a schematic cross-sectional view of the second repeating unit along a first straight line;

FIG. 4 shows a schematic cross-sectional view of the second repeating unit along a second straight line.

The repeating unit 10 schematically illustrated in FIG. 2 comprises an active surface 14 as well as a gas conducting region 8. The gas conducting region 8 is intended to conduct an oxidation gas 12, for example air, to and along the active surface 14. Upstream of the active surface 14, a first barrier 16 and a second barrier 17 are disposed in the gas conducting region 8. Downstream of the active surface 14, a third barrier 18, as well as a fourth barrier 19 are located in the gas conducting region 8. The barriers 16, 17, 18 and 19 are respectively formed by a manifold for conducting combustion gas in a direction (the z-direction 6) extending perpendicular to the image plane (the x, y-plane 2, 4). Each individual barriers 16, 17, 18, and 19 constitutes a flow obstruction, meaning that it prevents a linear flow of the oxidation gas 12 along the active surface in the x-direction. Non-linear channels 20, 22, 24, 26, 28, 30, 32, 34 for conducting the oxidation gas 12 along the active surface 14 are located on the active surface 14. The channels 20, 22, 24, 26, 28, 30, 32, 34 are formed so that the active surface 14 is more uniformly supplied with oxidation gas 12 in comparison to an arrangement comprising straight (linear) channels known from the state of the art. In particular, the channel 26 leads to a region of the active surface 14 which would remain undersupplied in a conventional, i.e., linear design of the flow field. The improved supply of the active surface 14 in a central section of the channel 26 can be explained by the fact that the two free ends of the channel 26 are not located directly behind the first barrier 16 or directly in front of the third barrier 18 but instead in regions adjacent to the first barrier 16 or the third barrier 18 where a higher flow density can he expected. The route of the channel 26 relative to the first barrier 16 can be described in more detail as follows. At a point 46 closest to the barrier 16, the first channel 26 defines a first flow direction. At a second point 48, the channel 26 defines a second flow direction. Here, a first straight line which extends through the first point 46 and is parallel to the first flow direction misses the barrier 16, while a second straight line 52 which extends through the second point 48 and is parallel to the second flow direction intersects the barrier 16. The route of the channel 26 in regards to the third barrier 18 can be described analogously.

The active surface 14 is rectangular and exhibits, in particular, a lower edge 54. Since it is to be expected that in case of an almost uniform incident flow on the active surface 14, the center of the active surface 14 heats up more than the edge regions of the active surface 14, it may be advantageous that channels located close to the edges (for example, channels 20, 22) have a smaller cross section and, thus, a lower cooling efficiency than channels further removed from the edge 54 (for example, channels 24, 26, 28, 30, 32, 34).

FIG. 3 shows a schematic cross-sectional view of the repeating unit 10 along line CD of FIG. 2. FIG. 4 shows a corresponding cross-sectional view of the repeating unit 10 along line AD of FIG. 2. The active surface 14 already described with reference to FIG. 2 is the surface of a cathode layer 38. The cathode layer 38 forms a membrane electrode assembly (MEA) 44 together with an anode layer 42 and a membrane 40 located between the cathode layer 38 and the anode layer 42. The MEA 44 allocated to repeating unit 10 is electrically connected to MEA 144 of an adjacent repeating unit not fully shown in the figure via a bipolar plate 36. The MEA 144 is identical to the MEA 44.

In the cross sectional view along line CD (see FIG. 3), the bipolar plate 36 extends in the y-direction 4 in an undulating fashion. At the same time, it defines the channels 20, 22, 24, 26, 28, 30, 32, 34 for conducting the oxidation gas 12 (see FIG. 2) as well as the channels 21, 23, 25, 27, 29, 31, 33 for conducting combustion gas along an active surface of the anode layer 142. In cross-section CD (FIG. 3), the channels 20 to 34 for conducting oxidation gas, as well as the channels 21 to 33 for conducting combustion gas are equally spaced and have identical cross sections. In the cross-section AD (FIG. 4), on the other hand, the channels 20 to 26 as well as the channels 28 to 34, respectively, form a group of channels separated by the channel 27, the width of which approximately corresponds to the width of the barrier 16 visible in FIG. 2.

In the design described with reference to FIGS. 3 and 4, the routes of the oxidation gas channels 20, 22, 24, 26, 28, 30, 32, 34 are strongly correlated to the routes of the combustion gas channels 21, 23, 25, 27, 29, 31, 33, as the oxidation gas channels are effectively interleaved with the combustion gas channels. Alternatively, however, it is also possible to design a gas conducting region for conducting the combustion gas along the anode 142 entirely independent from the shape of the gas conducting region 8 provided for conducting the oxidation gas 12.

Terms such as “top”, “bottom”, “left”, “right”, “vertical” and “horizontal”, where used, only indicate the relative positions or orientations of components of the described object. These terms do not designate a position or orientation with respect to a body or reference system not mentioned in the application, particularly not relative to the earth's surface.

### NUMERALS

2 x-direction

4 y-direction

6 z-direction

8 gas conducting region

10 repeating unit

12 gas

14 active surface

16 barrier

17 barrier

18 barrier

19 barrier

20 channel

22 channel

24 channel

26 channel

28 channel

30 channel

32 channel

34 channel

36 bipolar plate

38 cathode

40 membrane

42 anode

44 membrane electrode assembly (MEA)

46 point

48 point

50 straight line

52 straight line

54 edge

56 transverse surface

58 transverse surface

136 bipolar plate

138 cathode

140 membrane

142 anode

144 membrane electrode assembly (MEA)

1. A repeating unit for a fuel cell stack comprising a gas conducting region for conducting a first gas to and along an active surface, wherein a barrier is located in the gas conducting region and the gas conducting region comprises, at least across the active surface, a plurality of channels for conducting the first gas along the active surface, wherein at least a first channel among the plurality of channels defines a first flow direction at a first point located closest to the barrier and a second flow direction at a second point, wherein a first straight line which extends through the first point and is parallel to the first flow direction misses the barrier while a second straight line which extends through the second point and is parallel to the second flow direction intersects the barrier.

2. The repeating unit according to claim 1, wherein the barrier is located upstream or/and downstream of the active surface.

3. The repeating unit according to claim 1, wherein a cross sectional area of the first channel fully projects onto the barrier in a direction perpendicular to the cross sectional area.

4. The repeating unit according to claim 1, wherein at least the first channel extends beyond the active surface.

5. The repeating unit (10) according to claim 1, wherein the active surface is a partial surface of a membrane electrode assembly and at least the first channel extends beyond the membrane electrode assembly.

6. The repeating unit according to claim 1, wherein the channels extend in a streamlined fashion.

7. The repeating unit according to claim 1, wherein the barrier comprises at least one section of a duct for conducting a second gas.

8. The repeating unit according to claim 1, wherein the active surface is an active surface of a cathode

9. The repeating unit according to claim 1, wherein the repeating unit is designed for a uniform laminar flow of the first gas to the gas conducting region.

10. The repeating unit according to claim 1, wherein the channels are gas-tight with respect to each other.

11. The repeating unit according to claim 1, wherein the plurality of channels comprises a second channel and a third channel and a first edge of the active surface constitutes a closest edge of the active surface for the second channel as well as for the third channel, wherein the third channel extends closer to the first edge and has a smaller cross sectional area than the second channel.

12. The repeating unit according to claim 1, wherein the channels are formed so that in case of a uniform flow of the first gas to the gas conducting region the same amount of the first gas per time unit flows through each of the channels.

13. The repeating unit according to claim 1, wherein characterised in that the channels are at least partly defined by a bipolar plate.

14. A fuel cell stack comprising a repeating unit according to claim 1.

15. A vehicle with a fuel cell stack according to claim 14.

16. A combined heat and power generation equipment comprising a fuel cell stack according to claim 14.
